(19) United States
(12) Patent Application Publication
(10) Pub. No.: US 2015/0142687 A1
(43) Pub. Date: May 21, 2015

(54) STUDENT ACCOUNT DATA SYSTEM

(71) Applicant: V.P. SKYVIEW, L.L.C., West Des Moines, IA (US)

(72) Inventors: Robert Donald VanPolen, West Des Moines, IA (US); Travis Gerald McAvaddy, Johnston, IA (US); Ronald John McAvaddy, Des Moines, IA (US)

(73) Assignee: V.P. SKYVIEW, L.L.C., West Des Moines, IA (US)

(21) Appl. No.: 14/515,690

(22) Filed: Oct. 16, 2014

Related U.S. Application Data
(60) Provisional application No. 61/891,565, filed on Oct. 16, 2013.

(51) Int. Cl. G06Q 50/20; G06Q 10/00

(52) U.S. Cl. CPC G06Q 50/2057; G06Q 10/00
USPC 705/328

(57) ABSTRACT

A student account data system is provided. The system includes one or more processors and a machine-readable mediums storing a set of instructions that, when executed by the processor cause it to execute operations including gathering student data from at least a first program, create a student profile from the student data, and award at least one achievement based on the student data. Other operations may include providing a social media platform, gathering and displaying employment data, building a resume, providing a payment gateway, providing financial analysis, providing a communication gateway, and providing alerts when students reach specified criteria. The operations may be carried out via an application programming interface. Student data may include name, demographic information, achievements, benchmarks, financial information, curriculum, events, examples of student work, employment information, contacts, messages, social media, services performed, retail sales, grade information, client information, resume, continuing education information, attendance information, and/or class rank.

### CROSS-REFERENCE TO RELATED APPLICATIONS

This application claims priority from U.S. Provisional Application Ser. No. 61/891,565 filed Oct. 16, 2013 and entitled STUDENT ACCOUNT DATA SYSTEM.

### FIELD OF THE INVENTION

The present invention generally relates to software systems and methods. More specifically, the present invention relates to systems and methods for tracking student and school information, progress, and achievements.

### BACKGROUND

Both students and schools must maintain large quantities of information regarding both the school and each student. Such information may include: basic student demographic information, financial aid information, grade information, curriculum, job postings, and progress. Oftentimes, students and school faculty and staff must look to numerous sources to gather information. In some circumstances, students do not have direct access to the information, and school faculty and staff must look up information as requested. This is time-consuming and inefficient. In addition, because it is difficult for students to track their own progress, it is not uncommon for students to lose focus and motivation. Moreover, if a student is falling behind, it is often not noticed by the student or school officials before grades are finalized. At this time it may be too late for the student to pull up his or her grade.

Additionally, schools that utilize on-the-job training must track and evaluate student progress during on-site training. Typically this can include tracking the number of times a various task has been attempted and successfully completed by a student as well as financial information on the student's performance. Also, many times the on-site location operates as a business on its own When not hosting student training. Often it is difficult for students, school faculty, and on-site managers to track a student's progress. Additionally, it is often difficult for an on-site training location to integrate the revenues brought in by student-practitioners and accurately project cash-flows based on their work.

Accordingly, there is a need in the art for a system which can track all student data at an institution. This may include, but is not limited to, basic student information, financial aid information, grade information, curriculum, job postings, achievements, and progress. The system should be able to pull information from any type of program or system which houses this information. In addition, such a system should allow students, as well as school faculty and staff, to track their current progress. The system should also provide motivation to students. For example, such a system may allow students to earn achievements which may be shared with other students via social media within the system. In addition, the system should provide school administration, faculty, and staff with a gateway for viewing student information and progress. It should also provide on-site training location managers with point of sale data for student-practitioners as well as accounting and cash-flow projects for the revenue brought in by students at the location. The system should provide information regarding individual students as well as group progress, which may be used for purposes including but not limited to marketing, job placement, and reporting.

### SUMMARY

Accordingly, a student account data system is provided. In one embodiment, a system includes a processor and a machine readable medium. The machine-readable medium stores a set of instructions that, when executed by the processor, cause the processor to execute operations comprising gathering student data from at least a first program, creating a student profile from the student data, and awarding at least one achievement based on the student data. Operations may be carried out via an application programming interface. Additionally, the operations may include providing a social media platform. Students may share an earned achievement via the social media platform. The system may also gather and display employment data and build a resume based on the student data. Moreover, the operations may include providing a payment gateway wherein a student may make a payment to a school or a school may make a payment to a vendor.

The operations may further include providing a communication platform, such as where a school may communicate with at least one student via push technology and/or where a student may contact a school via a pre-populated contact form. The operations may also cause the processor to create a warning when student data reaches a preset value. In addition, the at least one achievement may be customizable. Student data may be selected from the group consisting of name, demographic information, achievements, benchmarks, financial information, curriculum, events, examples of student work, employment information, contacts, messages, social media, services performed, retail sales, grade information, client information, resume, continuing education information, attendance information, class rank, and combinations thereof.

In another embodiment, a student account data system may include a processor and a machine-readable medium storing a set of instructions that, when executed by the processor, cause the processor to execute operations including gathering student data from at least a first program, creating a student profile from the student data, awarding at least one achievement based on the student data, providing a social media platform, gathering and displaying employment data, providing a communication platform, providing a payment gateway, building a student resume, and creating a warning when the student data reaches a preset value.

The student data may be selected from the group consisting of name, demographic information, achievements, benchmarks, financial information, curriculum, events, examples of student work, employment information, contacts, messages, social media, services performed, retail sales, grade information, client information, resume, continuing education information, attendance information, class rank, and combinations thereof. Moreover, at least one of the operations may be carried out via an application programming interface.

In yet another embodiment of a student account data system, the system comprises a processor and a machine-readable medium. The machine-readable medium stores a set of instructions that, when executed by the processor, cause the processor to execute operations. The operations include gathering student data from at least a first program, creating a student profile from the student data, awarding at least one achievement based on the student data, providing a social media platform, gathering and displaying employment data, providing a communication platform, providing a payment gateway, building a student resume, and creating a warning when student data reaches a preset value. The student data is selected from the group consisting of name, demographic information, achievements, benchmarks, financial information, curriculum, events, examples of student work, employment information, contacts, messages, social media, services performed, retail sales, grade information, client information, resume, continuing education information, attendance information, class rank, and combinations thereof. In addition, at least one of the operations is carried out via an application programming interface.

### BRIEF DESCRIPTION OF THE DRAWINGS

FIG. 1. is a schematic of a student account data system according to one embodiment of a system of the present invention.

FIGS. 2-17 are user interfaces of an exemplary student account data system according to one embodiment of a system of the present invention.

FIGS. 18-19 are tables displaying exemplary achievements of a student data system according to one embodiment of a system of the present invention.

FIG. 20 is a schematic of a student account data system according to a second embodiment of a system of the present invention.

### DETAILED DESCRIPTION

The following is a detailed description of an embodiment of a student account data system 100 (sometimes “system”). One particular use of such a system 100 is for gathering and maintaining student data at a cosmetology school. Accordingly, for ease of discussion and understanding, the following detailed description will refer to the aforementioned cosmetology embodiment of the present invention. However, it will be appreciated by one skilled in the art that a system of the present invention may be used in other schools and professions. As such, information which is gathered and displayed may be varied without departing from the scope of the invention. At a cosmetology school, the system. 100 combines both “front of the house” salon life and “back of the house” education life into one easily accessible tool for facilitating both school and student progress.

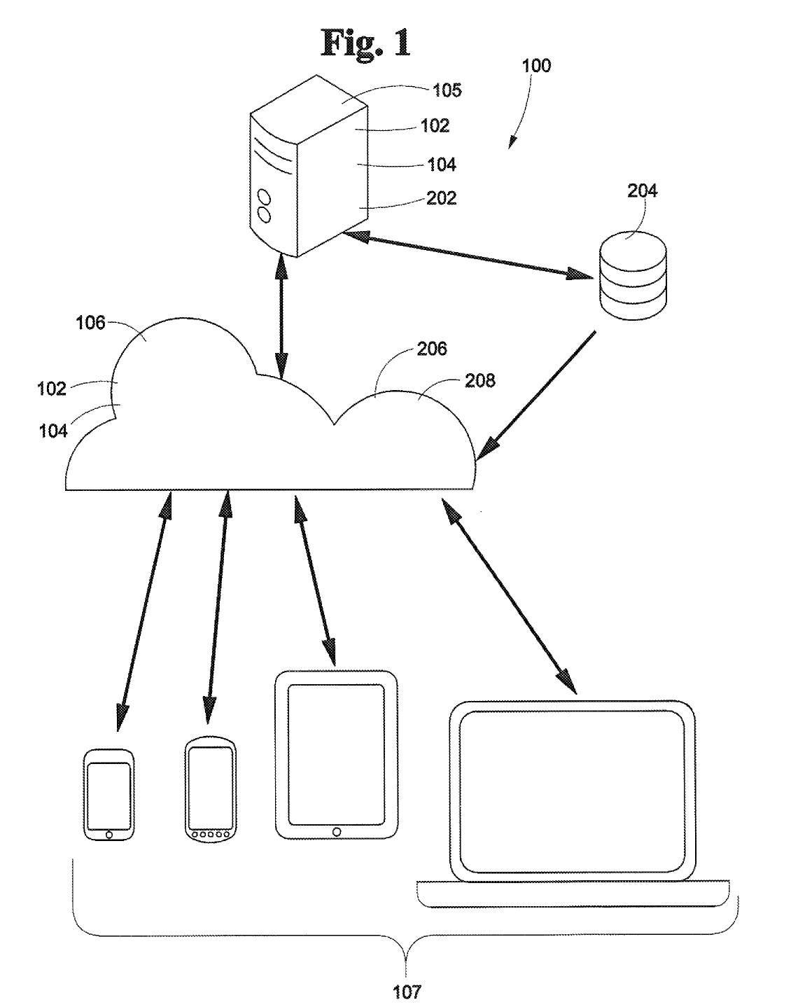

Referring to FIG. 1, a schematic of an embodiment of a system 100 of the present invention is provided. The system includes one or more processors 102 and machine-readable mediums 104. In the preferred embodiment, a processor 102 and machine-readable medium 104 are housed in a local server 105. The local server 105 may also house data sources 202 for the system 100 as discussed herein below. Additionally, another processor 102 and machine-readable medium 104 are housed in a remote/cloud server 106. The cloud server 106 also holds the internal database 206 of the system 100 as well as the system rules 208, as further discussed below, for implementation by the system 100. However, it should be appreciated by one skilled in the art that the local server 105 and remote server 106 can be located interchangeably, or both may be located locally or remotely, without departing from the spirit of the current invention. Additionally, it should be appreciated by one skilled in the art that the local server 105 and cloud server 106 may be integrated into a single unit located either remotely or locally without departing from the spirit of the current invention. Accordingly, when appropriate, the two components will be referred to collectively as “servers” 105 and 106. The servers 105 and 106 may also integrate with one or more outside data sources 204 as discussed herein below.

In the preferred embodiment, the local server 105 is located at the school. The local server 105 connects and communicates with the cloud-based server 106 that creates a student profile, which will be described in further detail below. The machine-readable medium 104 stores a set of instructions that, when executed by the processor 102, cause the processor 102 to execute operations. The operations include, but are not limited to, gathering student data from at least a first program, creating a student profile from the student data, and awarding at least one achievement based on the student data. Student data may include, but is not limited to, name, demographic information, achievements, benchmarks, financial information, curriculum, events, examples of student work, employment information, contacts, messages, social media, services performed, retail sales, grade information, client information, resume, continuing education information, attendance information, class rank, and combinations thereof.

The student data may be gathered from any program, including those that are tailored to higher education or specifically to the cosmetology profession and generalized programs, such as Microsoft Excel. Tailored programs may include, but are not limited to, Smart, Millennium, Fame, and SalonBiz. Other programs may include hose which house financial aid, accounting and point of sale retail information, including but not limited to Peachtree accounting software. Data is gathered by the system 100 via an application programming interface (“API”), batch download, real-time download, and/or manual input. As is known in the art, an API is source code that directs the interaction between multiple types of software. For example, in the present invention the system 100 gathers data from other programs for display via the API. In the preferred embodiment, the system 100 operates as a third party plug-in to existing programs to pull and consolidate data. The system 100 dictates how the data will be sorted, organized, and presented to users. As one skilled in the art will appreciate, other methods providing for interaction between the system 100 and other software programs may be employed without departing from the scope of the present invention. However, a benefit of using an API-based system 100 is that it can work with all other software programs, whether now existing or created in the future. Accordingly, schools in a related network, such as those affiliated with a common brand, which use different types of software to store data may all use the system 100 of the present invention. In addition, use of the system 100 does not interrupt existing workflow and allows schools to seamless switch underlying software programs as desired.

The system 100 of the present invention consolidates the data it has gathered from at least one, but generally multiple, other software sources or programs, into the internal database 206. The system 100 uses the gathered and consolidated data to create a student profile. The preferred system 100 of the present invention may display the student profile on any device or operating system 107 known in the art now or in the future. Devices 107 include, but are not limited to, an Apple iPhpne, Android phone, Apple iPad, Nook, other mobile and tablet devices, Internet television, and laptop or desktop computers. Operating systems 107 include, but are not limited to, Mac, PC, Android, IOS, or Internet TV. Accordingly, the system 100 presents the student data in a usable format to the students. Students may monitor their goals, benchmarks, achievements, grade point average, attendance record, and school curriculum in a real-time or nearly real-time format. The system 100 may be programmed to pull information from the existing software and data sources 202 and 204 as often as desired. Accordingly, information is pulled into the system 100 as soon as, or shortly after, it is updated in the underlying software. Much of the information such as point of sale retail transactions and services, financial information, and current grades are often continually updated throughout the day. Therefore, students may use the system 100 to view real-time or nearly real-time information to retain focus and motivation as classes progress.

Although in the preferred embodiment the system 100 is generally student-oriented, school officials, such as administration, faculty, and staff, are also able to view all or part of the student information and reports related to same. Moreover, school information, such as high level information, may be gathered and viewed by school governing bodies, such as administration, owners, and those from a brand with which the school is affiliated. Accordingly, it is easy to identify students who have risen to the top of the class, as well as those who may need extra help. In one embodiment, school officials and/or students receive a warning or alert from the system 100 when a student falls below specified criteria or a preset value within the system 100 as defined by the administrator in the system rules 208. Additionally, school officials may use the system 100 to communicate with students, as will be discussed in further detail below.

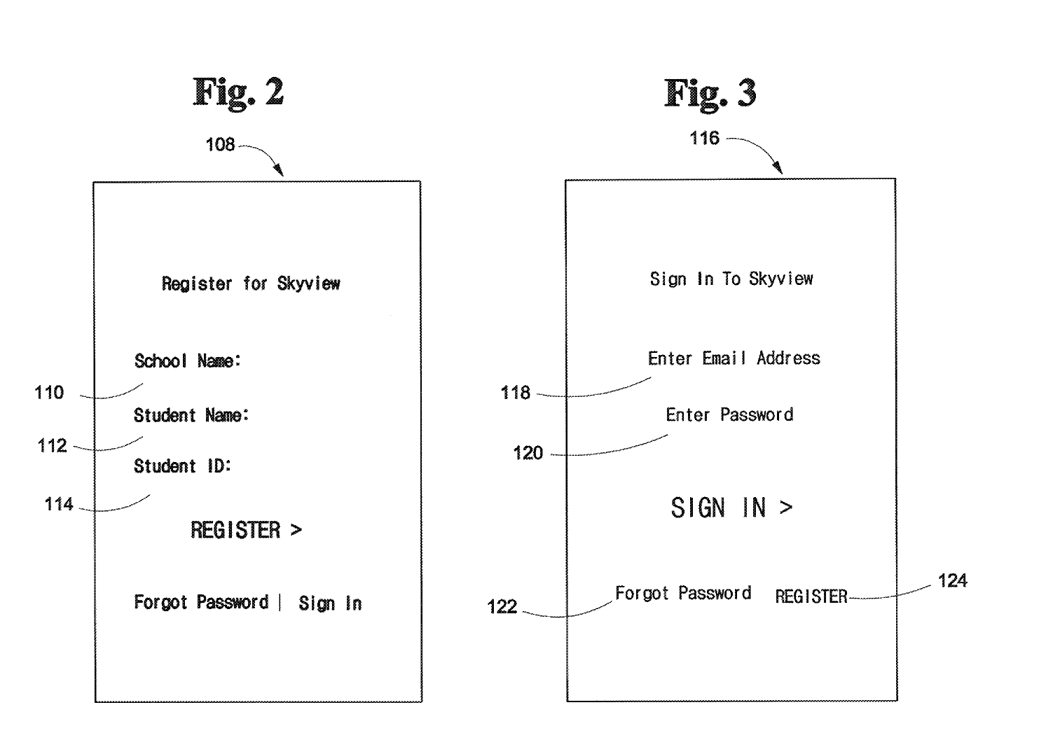

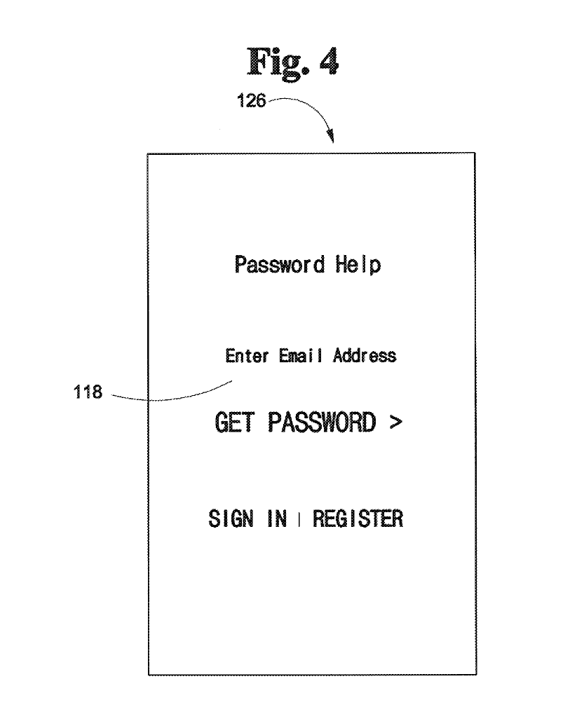

Referring to FIGS. 2-17, user interfaces of a system 100 of the present invention are provided. It will be understood by one skilled in the art that the provided user interfaces are exemplary only, and the user interfaces of a system 100 of the present invention may take many forms. FIG. 2 illustrates a registration screen 108 of a system 100 of the present invention. The registration screen 108 includes school name 110, student name 112, and student ID 114 fields. It is anticipated that the system 100 of the present invention will be used at a number of cosmetology schools, including those which are affiliated with a common brand. Turning to FIG. 3, a login screen 116 is provided. A user may enter his or her email address in the email address field 118 and password in the password field 120 to login to the system 100 software. The login screen 116 also provides a “Forgot Password” link 122 to access a Password Help screen 126, as well as a “REGISTER” link 124 to access the registration screen 108 shown in FIG. 2. As shown in FIG. 4, if a user clicks the “Forgot Password” link 122, the user is taken to the Password Help screen 126. At this screen 126, the user may enter an email address in the email address field 118 to obtain password help.

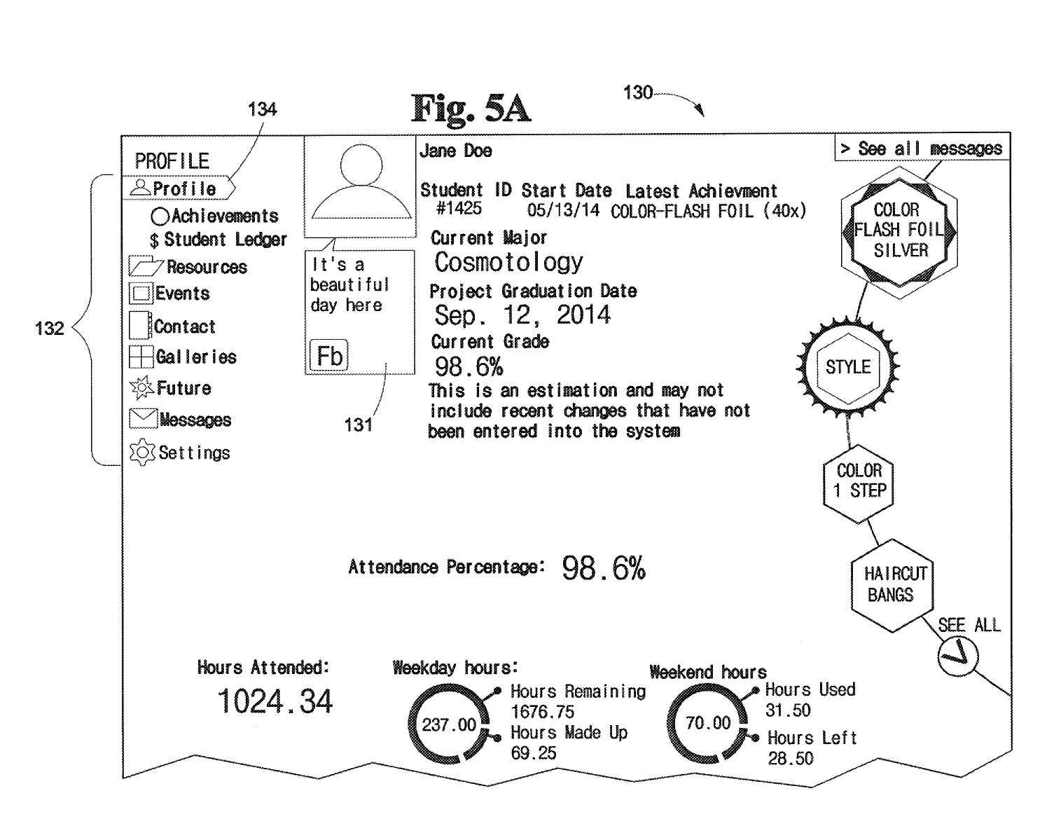

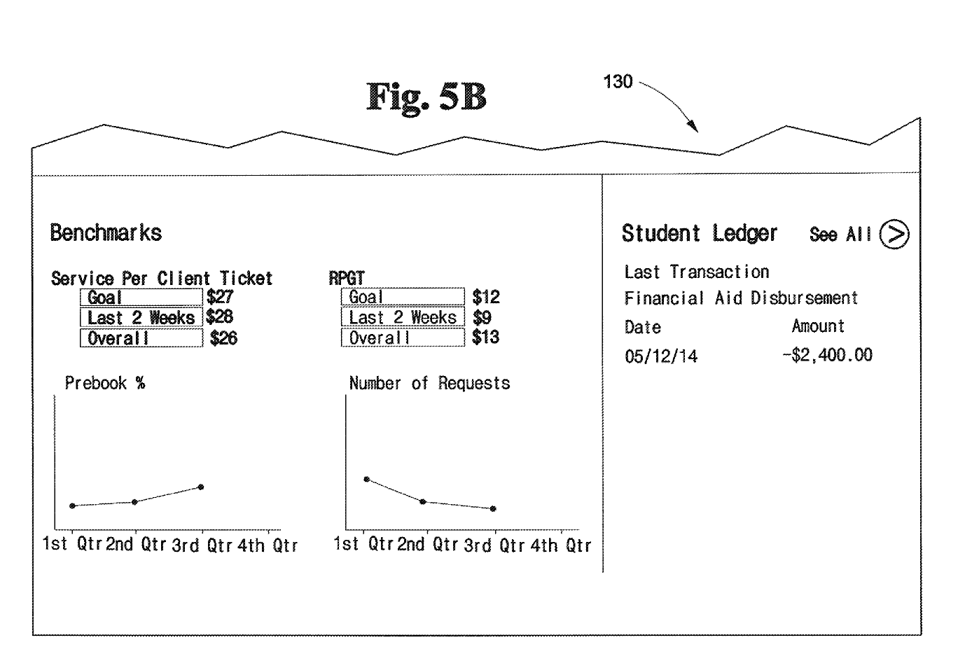

The system 100 of the present invention may be accessed by students; school faculty, staff, and administration; potential employers; salon owners and more. The remaining user interfaces are directed to students. Accordingly, while the user interfaces will be described for use by students, it will be understood by one skilled in the art that the system 100 also includes user interfaces for others affiliated with the school. As illustrated in FIGS. 5A and 5B, once a student has successfully logged into the system 100, the student is taken to the dashboard 130, which may be a pseudo-dashboard. The dashboard 130 includes a number of tabs 132 on the left-hand side. By clicking on the tabs 132, the student may access information and screens including the student's profile, achievements, ledger, resources, events, contact to the school, galleries, future, messages, and settings.

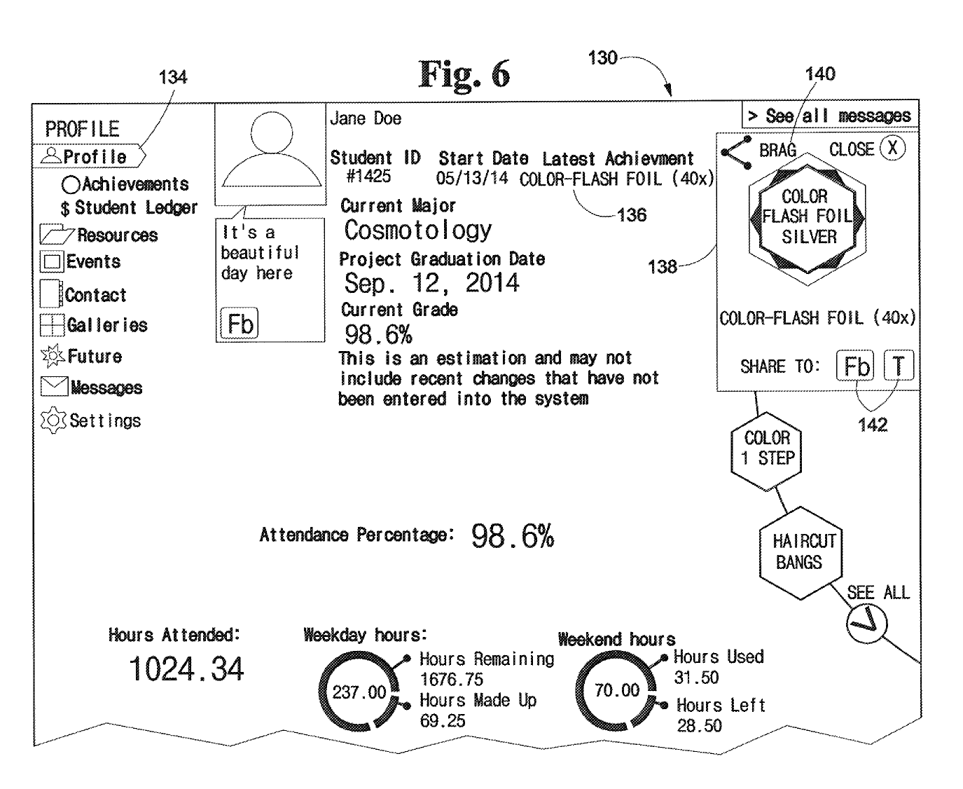

In the dashboard 130 shown in FIGS. 5A and 5B, the Profile Tab 134 has been selected. The Profile Tab 134 displays general information about the student. This may include, but is not limited to, the student's ID, start date, latest achievement, possible achievements, major, projected graduation date, current grade, attendance details, benchmark information, and recent ledger information. It is anticipated that in some embodiments, only students will have access to financial information. In addition, a status bubble 131 is provided where the student may post a status update, which may be shared with the internal social media platform, as well as with external social media platforms, such as Facebook. Turning to FIG. 6, the dashboard 130 Profile Tab 134 is again shown. By clicking on the latest achievement link 136, an achievement detail box 138 is displayed. This box includes a “Brag” link 140, as well as links 142 to share the achievement to social media sites, such as Facebook and/or Twitter. By clicking the “Brag” link 140, the student may share the achievement on a social media platform that is provided by the system 100, such as to cliques or groups of classmates. By clicking the share to social media links 142, the student may share the achievement on one or more platforms such as Facebook and/or Twitter, respectively.

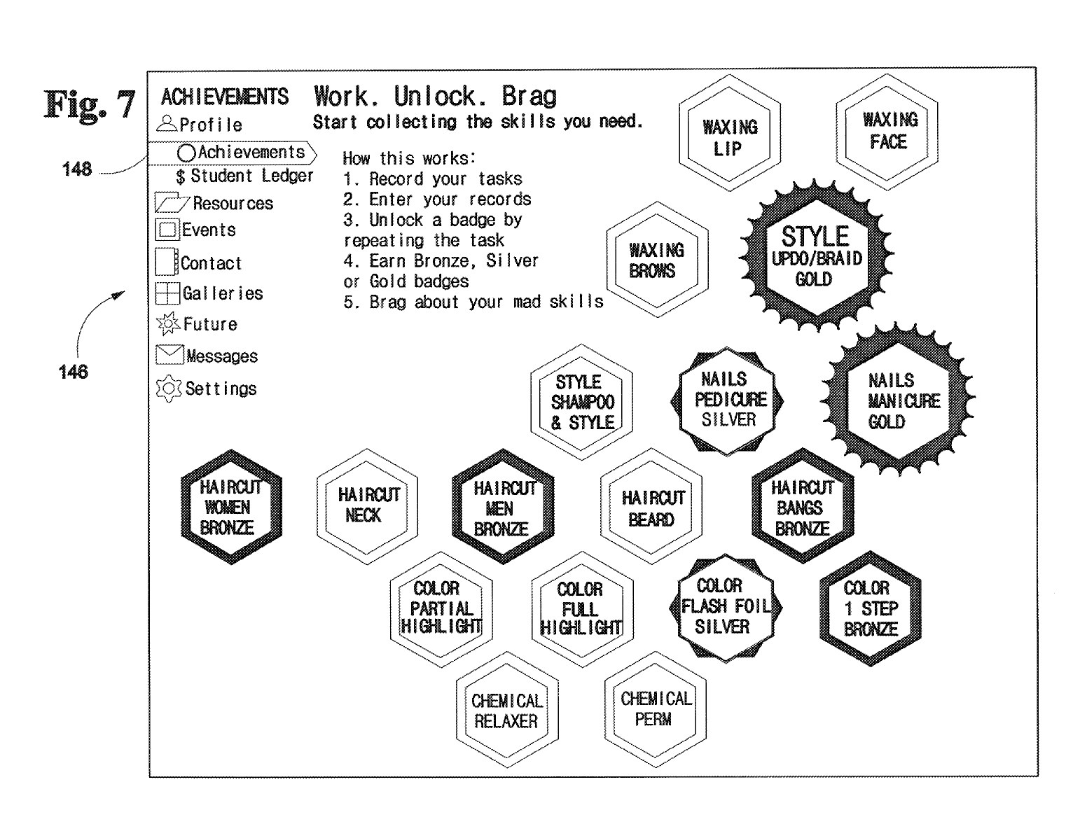

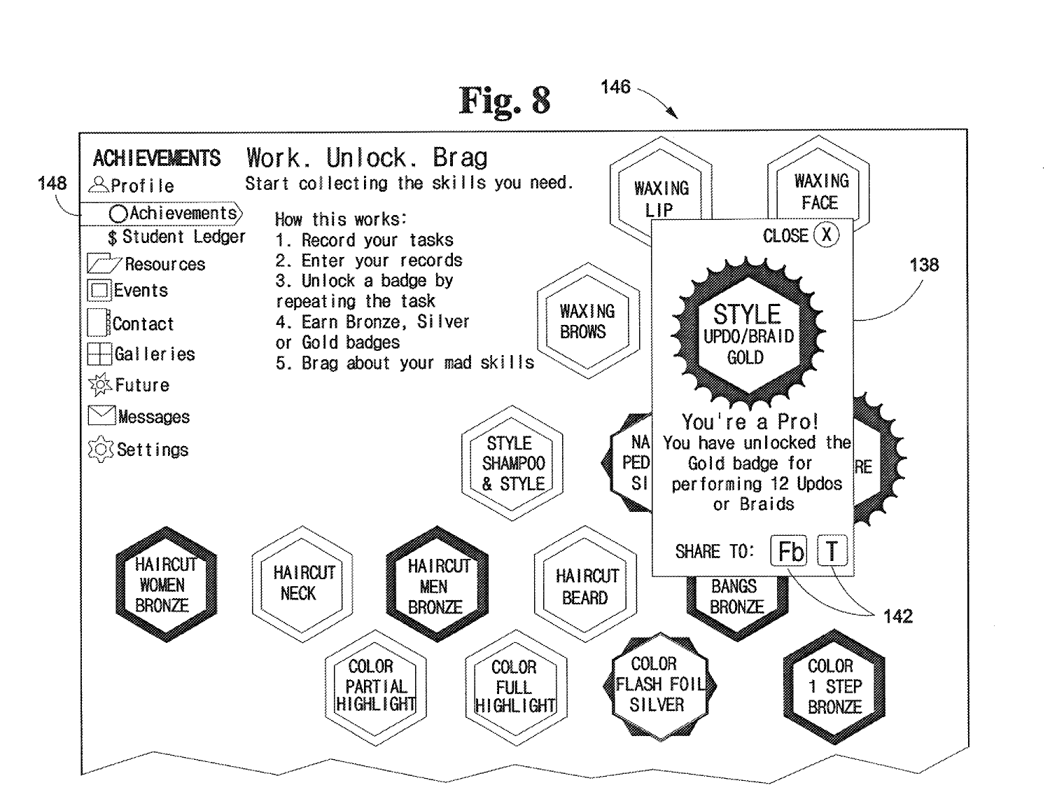

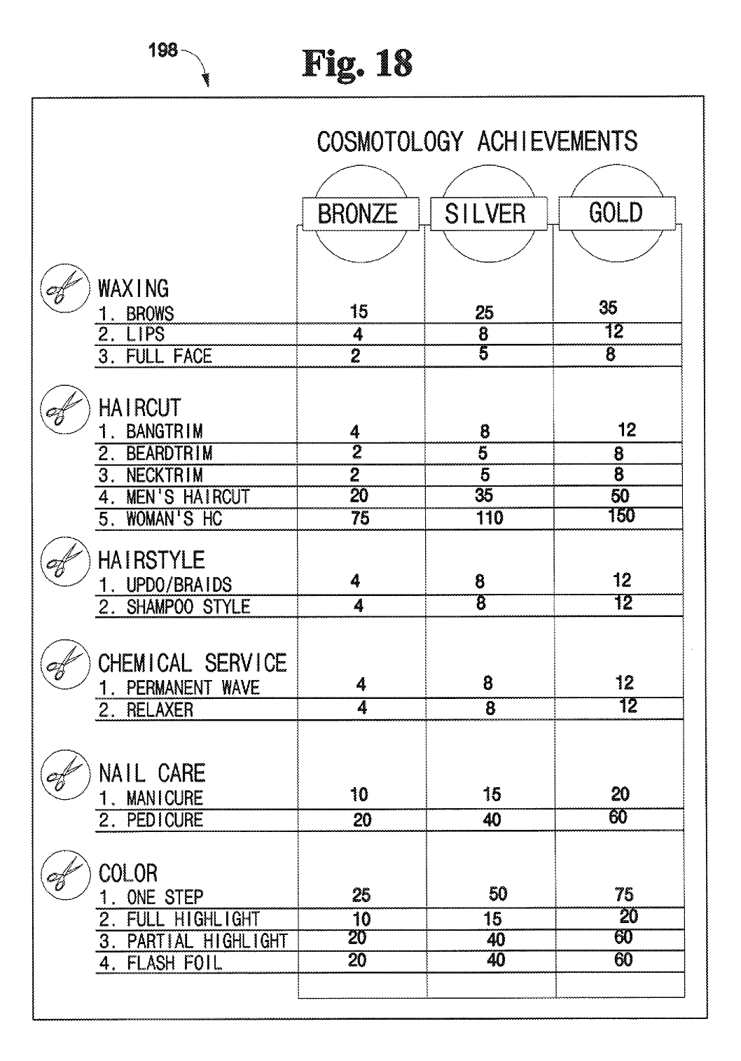

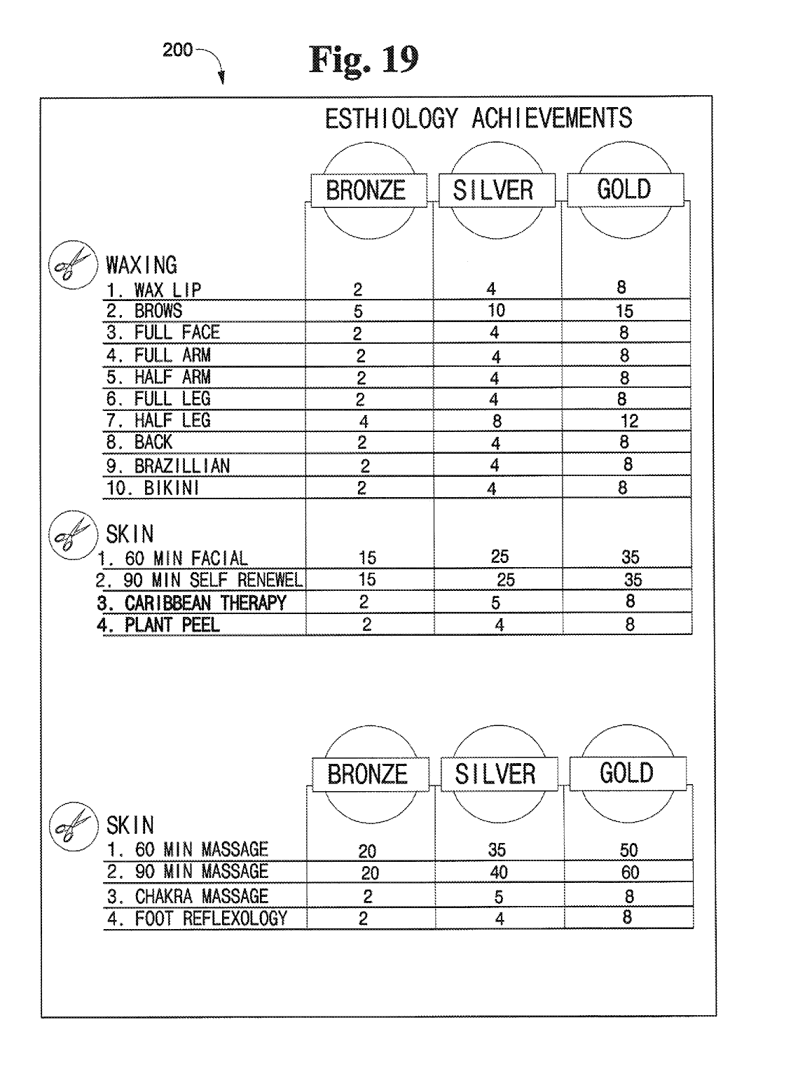

Referring to FIG. 7, the dashboard 130 “Achievements” screen 146 is shown. This screen is accessed by clicking the “Achievements” tab 148 on the left side of the screen. As shown in FIG. 8, the student may click on an earned achievement to display the achievement detail box 138. The achievement detail box 138 includes links 142 to share the achievement on social media, such as Facebook and Twitter. Furthermore, FIGS. 18-19 provide tables 198, 200 of exemplary student achievements. Student achievements are customizable within the system 100, such as by school administration, to correspond to values that are appropriate for the particular school. These values may be setup and implemented by school administration in the system 100 using pre-defined system rules 208. In the described cosmetology embodiment, achievements may relate to the quantity of services performed by a student in categories such as cosmetology, esthiology, and massage therapy. Achievements are earned, displayed, and shared in a celebratory manner so as to encourage and motivate students. The system 100 may also provide a means for the school and other students to congratulate a student on his or her achievements. Accordingly, achievements help students remain goal-focused and competitive. In some embodiments, it is also anticipated that limited profile information may be shared by students in the system 100. Such a “mini-profile” will also act as a motivational tool for students to share progress and to spur healthy competition between classmates.

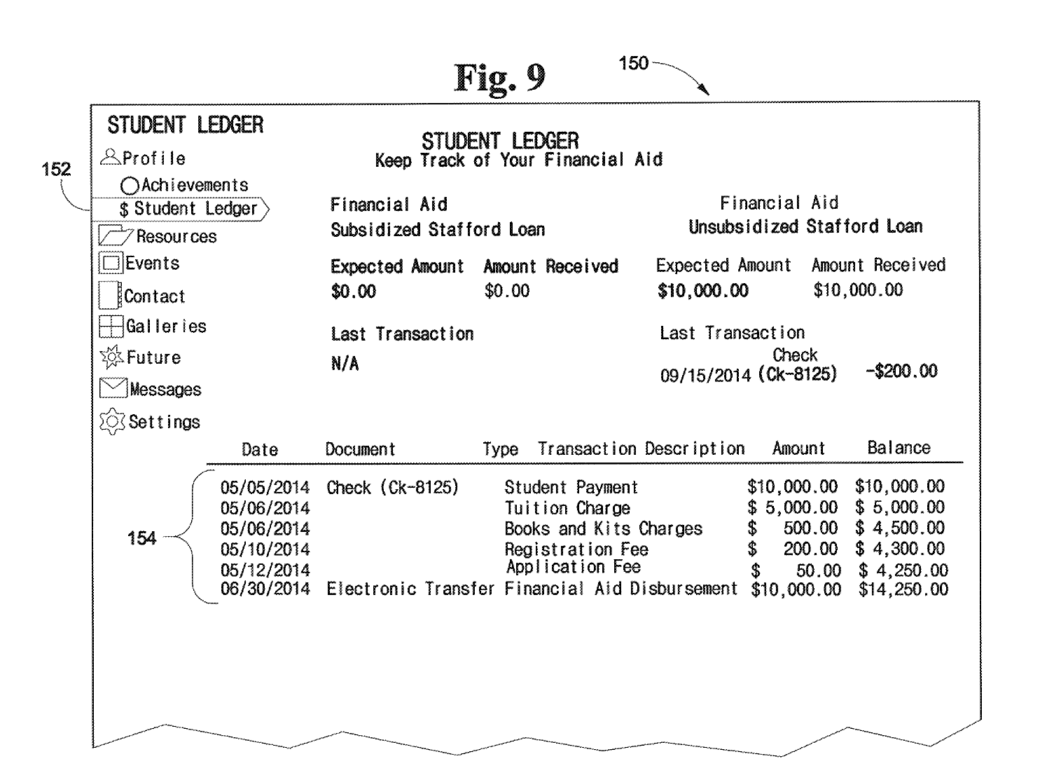

Referring to FIG. 9, the dashboard 130 “Student Ledger” screen 150 is shown. This screen 150 is accessed by clicking the “Student Ledger” tab 152 on the left-side of the dashboard 130. The “Student Ledger” screen shows information regarding received and disbursed financial aid, as well as a detailed transaction section 154 showing detailed ledger transactions, such as fees, charges, payments, expenses, and financial aid disbursements. The administrative side of the system 100 would allow authorized school administration to view financial aid information for students as well as coordinate the admissions process for each new group of students admitted to the school.

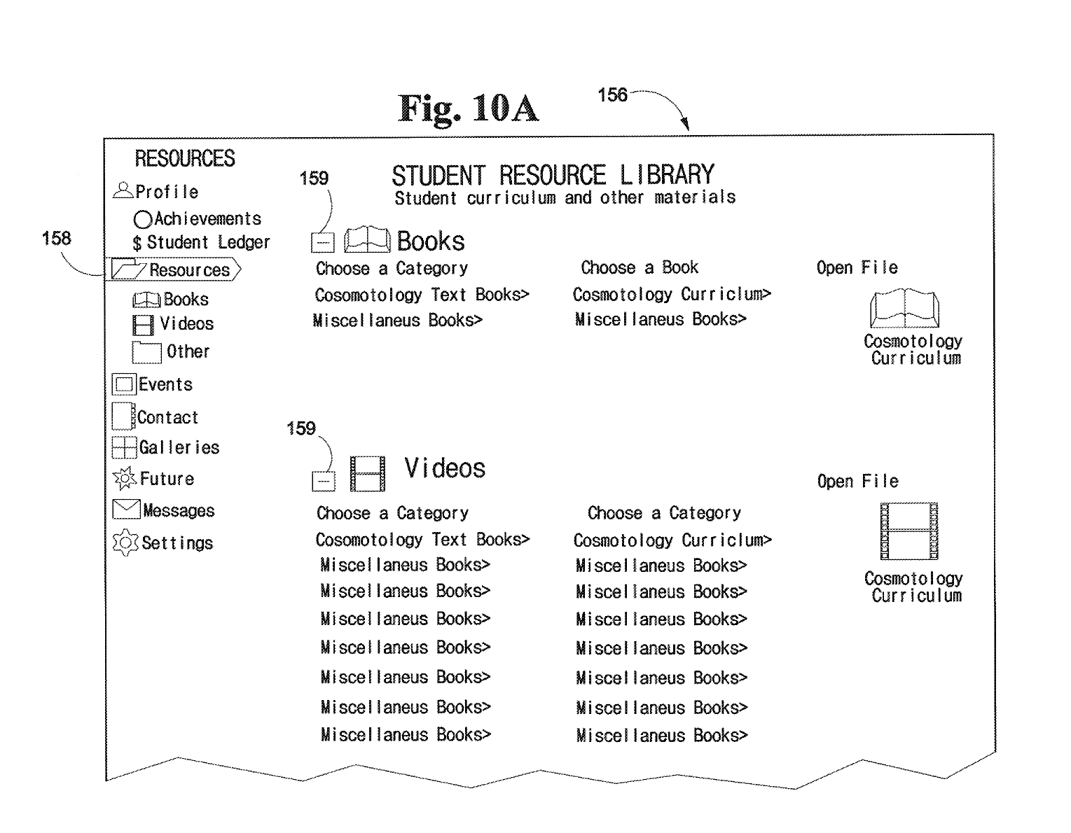

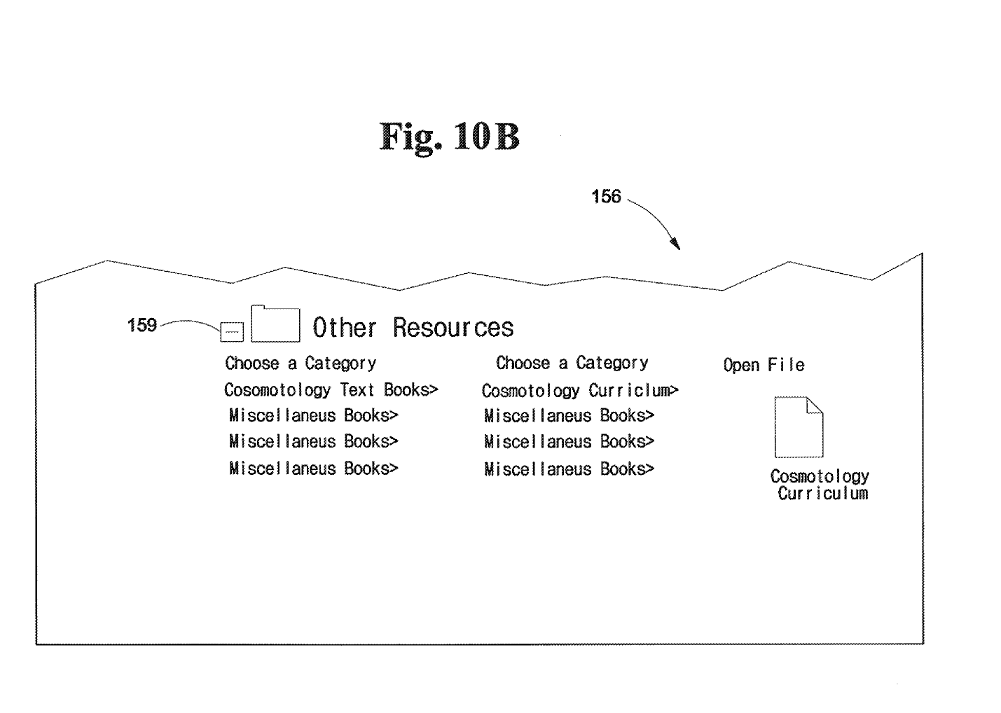

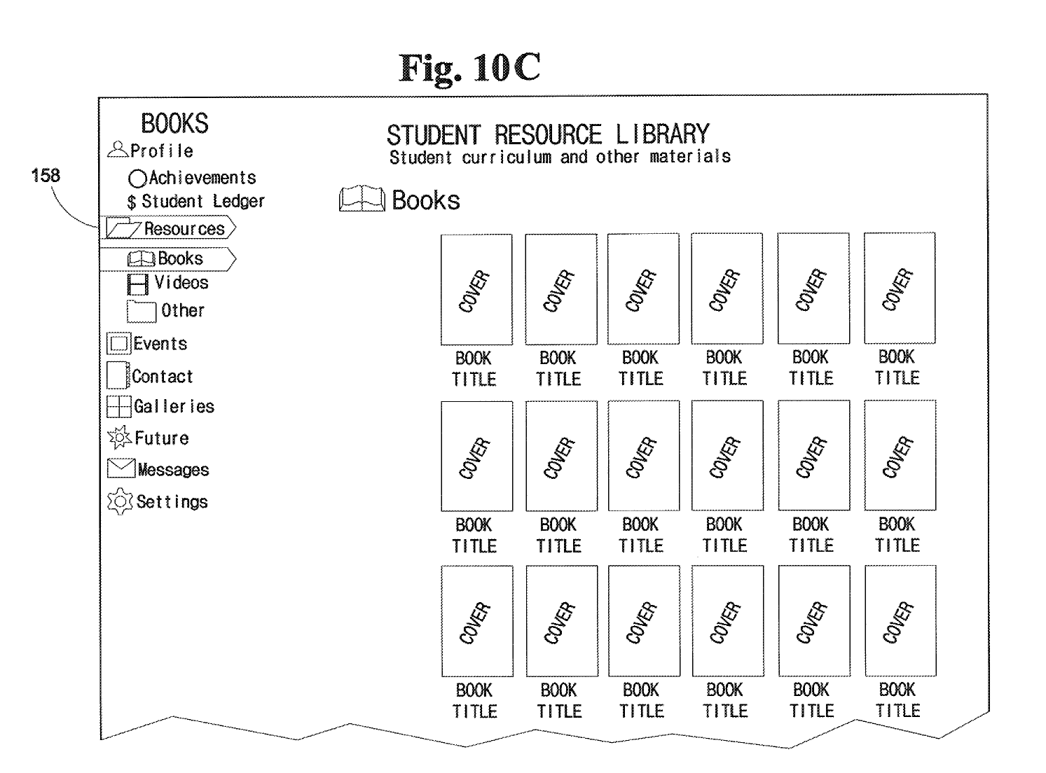

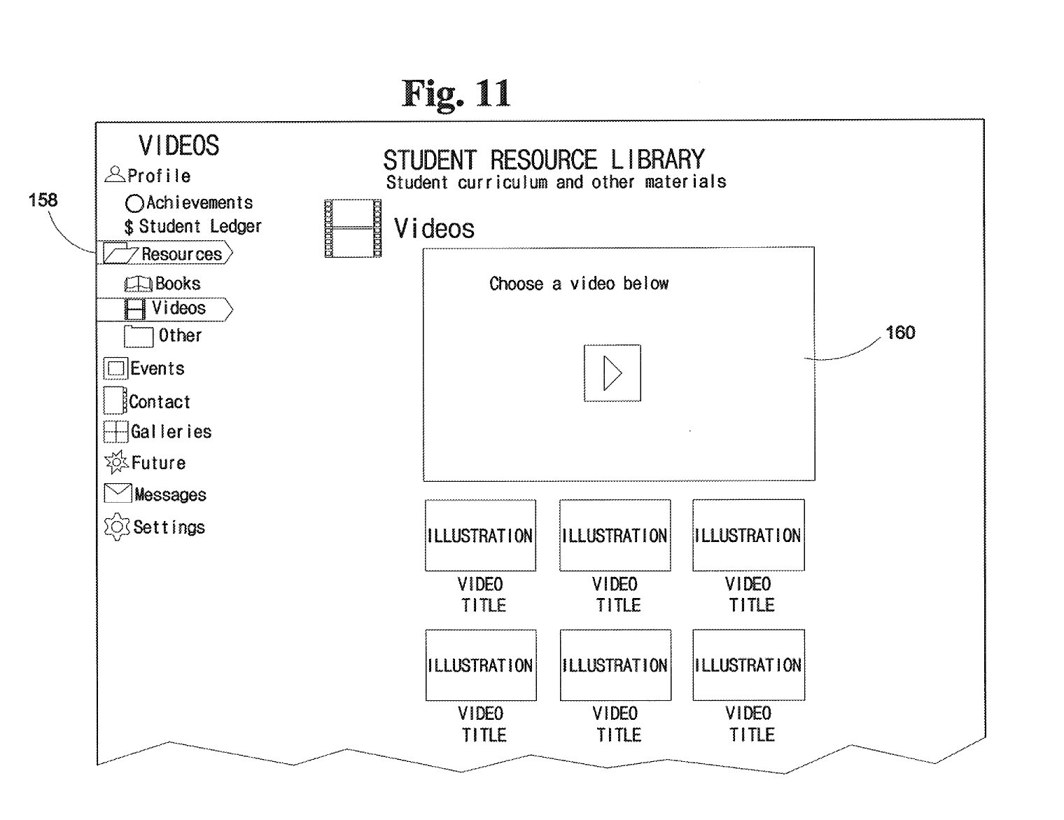

Turning to FIGS. 10A and 10B, the “Resources” screen 156 is shown. The “Resources” screen 156 is accessed by clicking the “Resources” tab 158 of the dashboard 130. The “Resources” screen 156 includes the student's curriculum, as well as further helpful resources that have been posted by the student's educators. Resources may include, books, videos, and miscellaneous other resources. The student may click the “−” sign 159 next to the Books, Videos, and Other Resources sections to hide the associated content. The “−” sign will then turn to a “+” sign, which may be clicked to display the associated content. The Other Resources section can include tests and quizzes for students to self-evaluate their level of preparedness for both school examinations as well as any applicable licensure examinations. As illustrated in FIG. 10C, the student may click on one of the tabs below the “Resources” tab 158 to directly access that type of resource, i.e. book resources. As shown in FIG. 11, the student may watch a selected video 160 from within the system 100 as well.

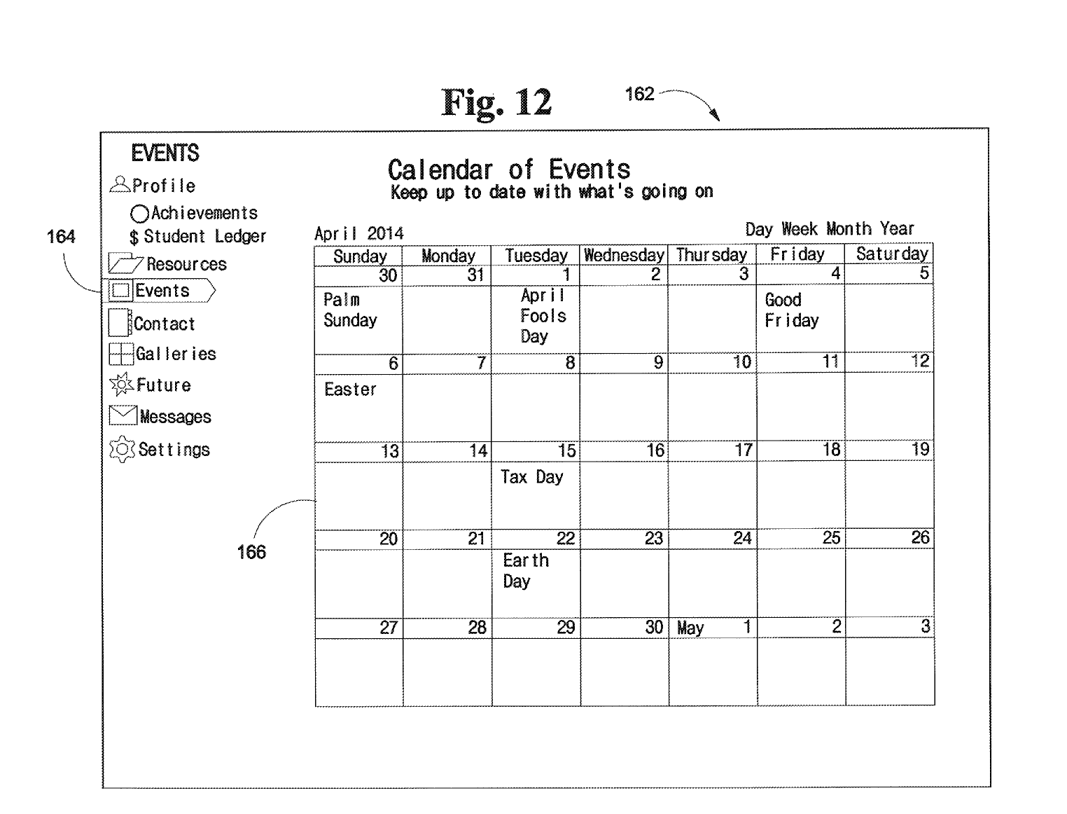

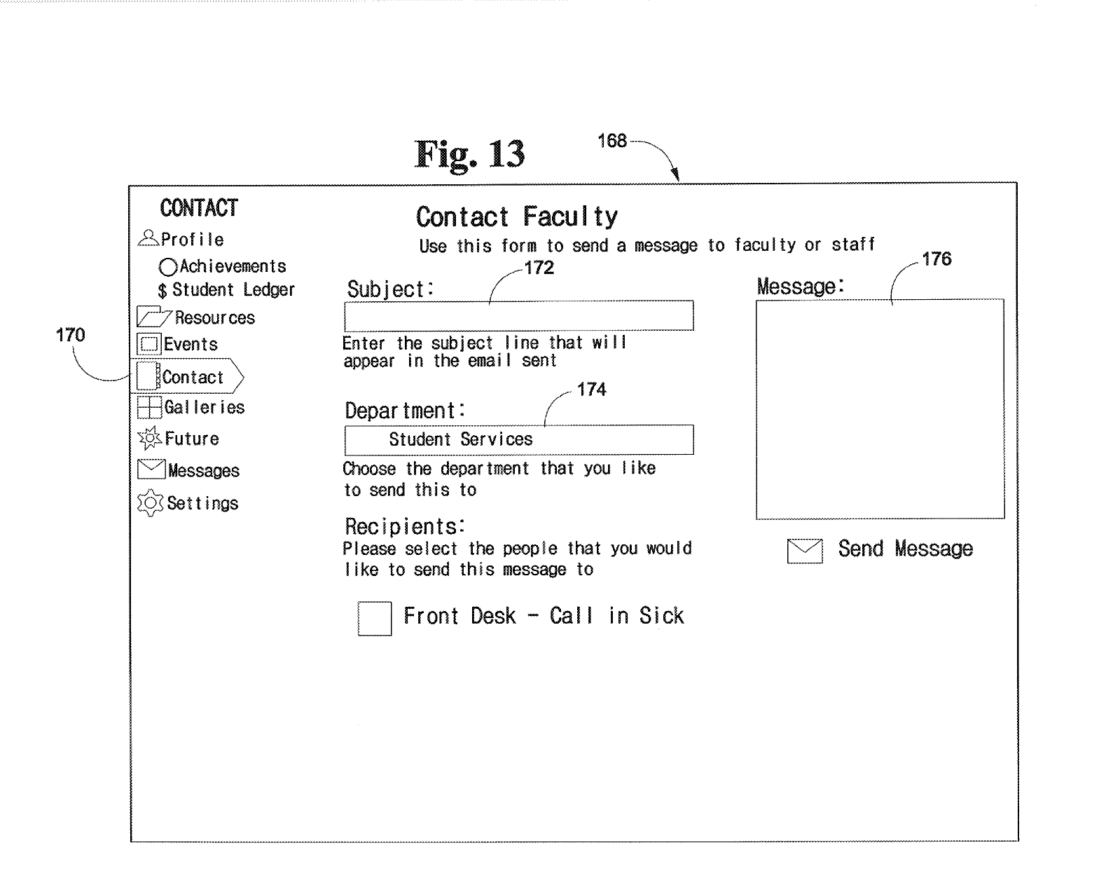

FIG. 12 provides a user interface of an “Events” screen 162 of the system 100. A student may access the “Events” screen 162 by clicking the “Events” tab 164 of the dashboard 130. The “Events” screen 162 displays a calendar 166, which may be manipulated to view by day, week, month, and year. FIG. 13 provides a “Contact” screen 168. The “Contact” screen 168 is accessed by clicking the “Contact” tab 170 of the main dashboard 130. Through the “Contact” screen, students may complete fields of a contact form to send a message to faculty or staff. It is anticipated that this screen will be pre-populated with the names and departments of the faculty and staff. Accordingly, this screen will be customized from school to school as the appropriate data is pulled from each school's existing program storing faculty and staff information. Fields which may be completed by the student include a subject field 172, department scroll list 174, and Message field 176. In addition, students may use the contact form to call in sick to the school's front desk. Therefore, the system 100 provides a complete school Rolodex for each student.

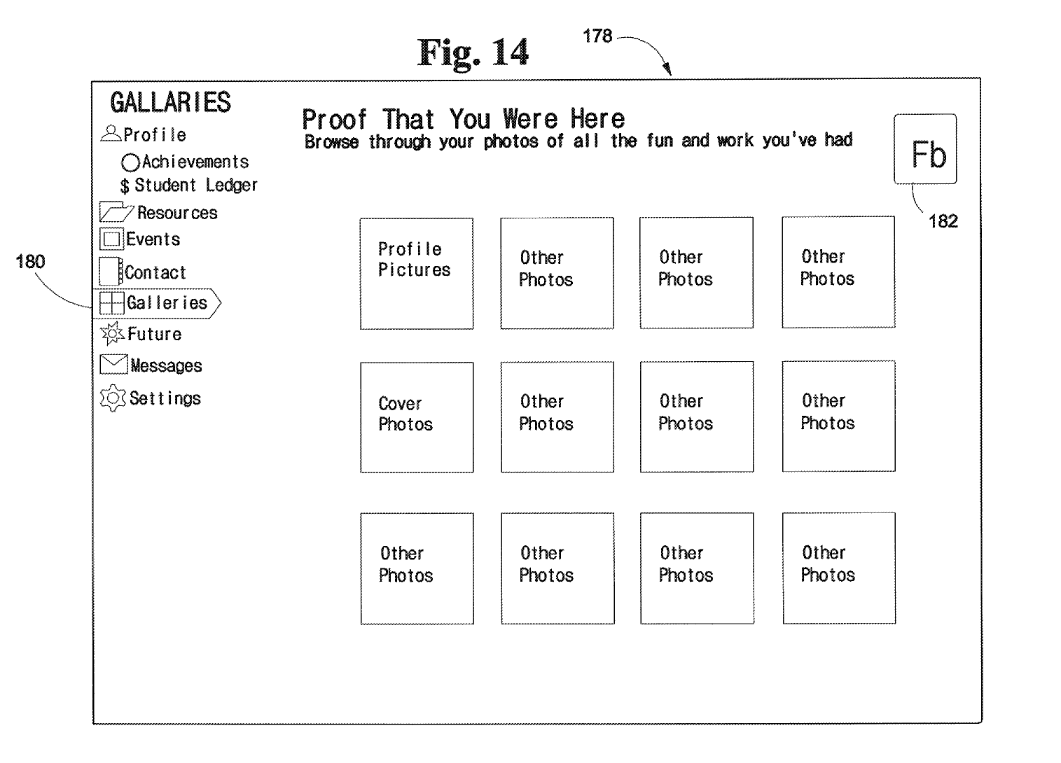

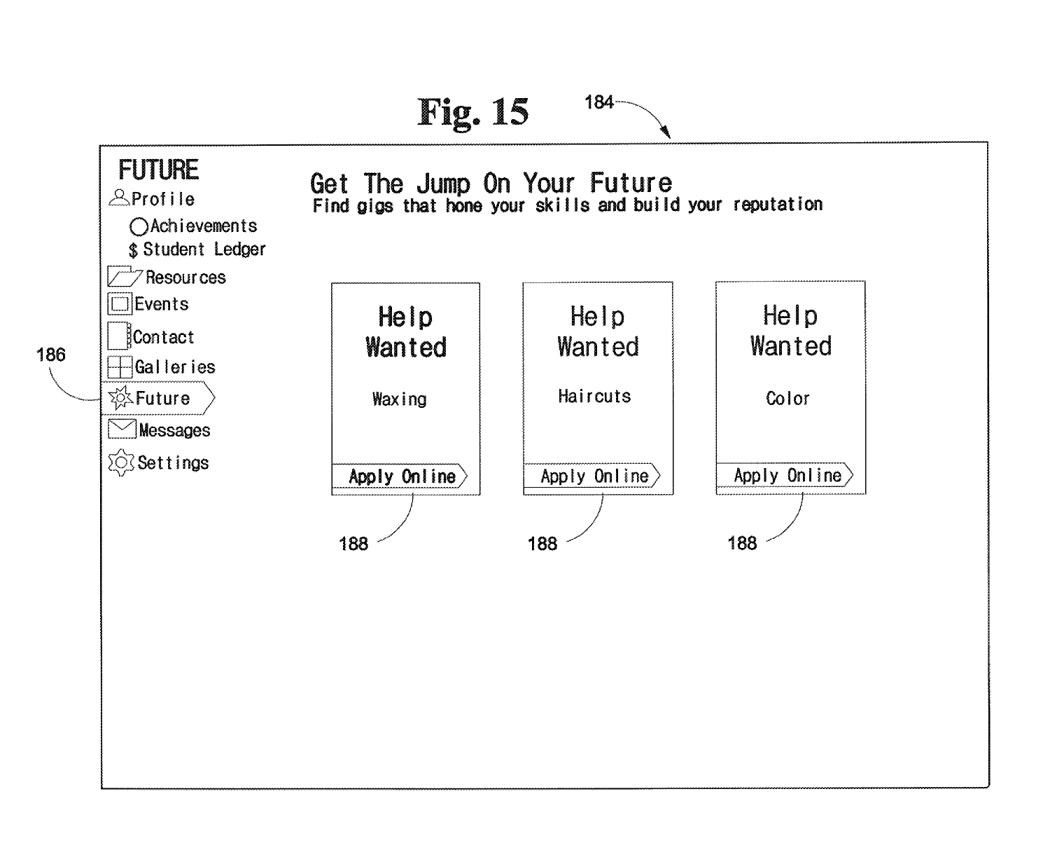

Referring to FIG. 14, a “Galleries” screen 178 is shown. The “Gallery” screen 178 is accessed by clicking the “Galleries” tab 180 on the main dashboard 130. Galleries including photographs and other media may be added to the system 100 by school officials. The galleries may be linked with social media, such as Facebook, by clicking the appropriate link 182. In the preferred embodiment, the “Galleries” screen 178 directly pulls photographs and/or other media from social media platforms, i.e. Facebook, such as the school's or student's pages. Moreover, turning to FIG. 15, a “Future” screen 184 is shown. The “Future” screen 184 is accessed by clicking the “Future” tab 186 of the dashboard 130. Potential employers may post job openings through the system 100, which are displayed on the “Future” screen 184. Moreover, the system 100 provides “Apply Online” links 188, which the student may click on to apply for the position directly through the system 100. Additionally, the system 100 allows students to search for and select businesses and/or individuals, related to the vocation(s) in which they are interested, that they would like to receive mentorship and guidance from. Also anticipated is a resume feature that allows the student to build a resume using information from within the system 100 as well as manually entered by the student. The system 100 provides one or more resume templates that the student selects from and utilizes. The resume built by the system 100 may be directly sent to potential employers along with other necessary application materials, i.e. cover letter, portfolio, etc., through the online application links 188 of the system 100.

Potential employers may also view information in the system 100 related to the schools) and students). For example, potential employers may view high level school information to determine which schools to target for future employees. The employers may also view student-specific information to determine which students to interview, such as at career fairs and campus visits. To that end, as mentioned above, a system 100 of the present invention may include a resume-builder feature. School officials, potential employers, and/or students may choose information to be submitted to potential employers, which may include, but is not limited to, grade point average, retail sales, photographs of previous work, and achievements earned. In the preferred embodiment, the system 100 may auto-populate some or all of the information to be included in a student's resume. It is anticipated that resumes may be used to apply for specific jobs or given to potential employers as requested, such as in advance of a career fair or campus visit. Accordingly, the hiring process is streamlined for all involved.

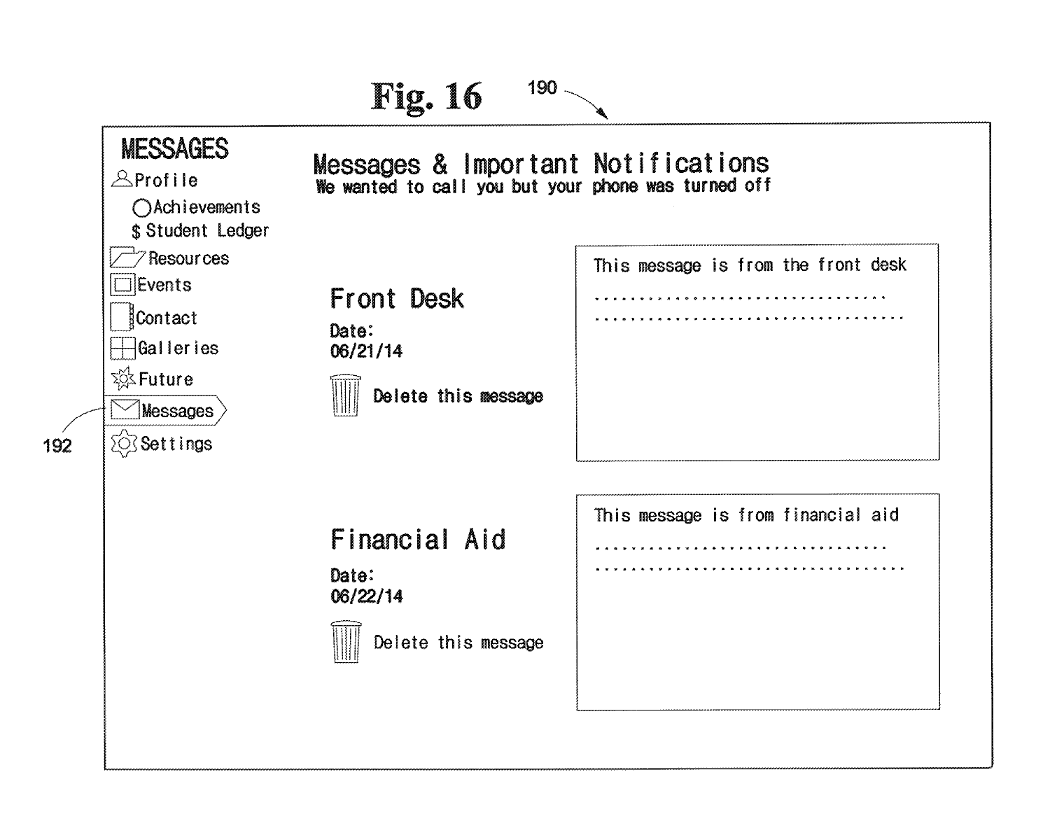

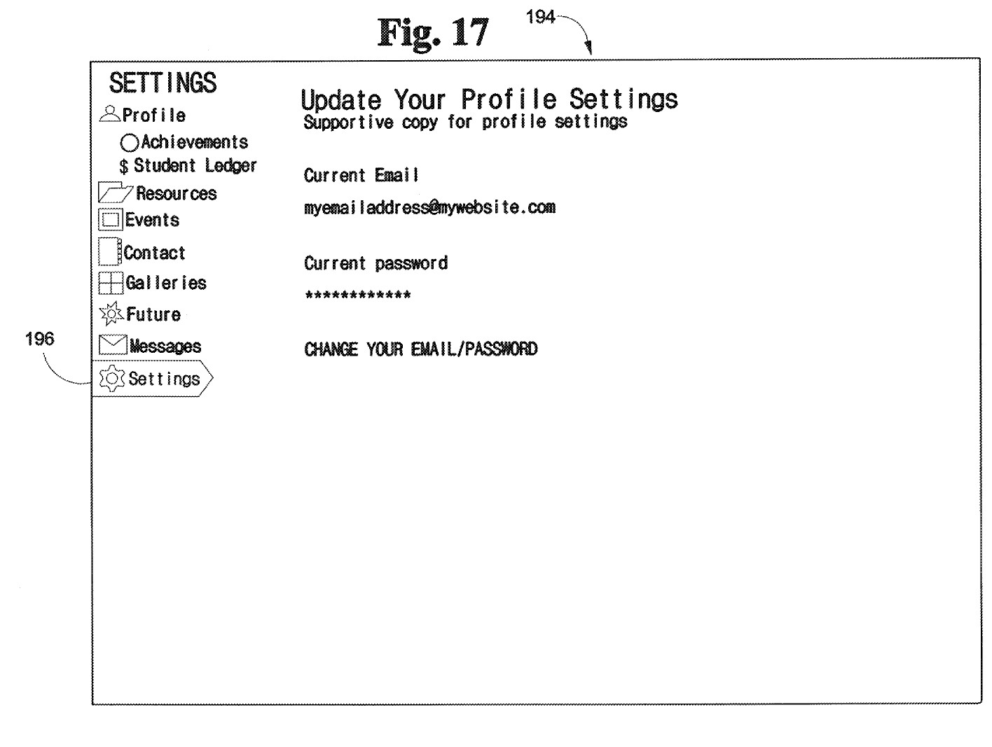

FIG. 16 provides an example of a “Messages” screen 190 of the exemplary system 100. The “Messages” screen is accessed by clicking the “Messages” tab 192 on the dashboard 130. School administrators, faculty, and staff may send messages to students through the system's 100 communication platform. In the preferred embodiment, the communication platform employs push technology for this function. However, any method known in the art, now or in the future, may be used to communicate within the system. Moreover, it is anticipated that in embodiments, students may use the system to directly communicate with each other, as may school faculty and staff. Turning to FIG. 17, a user interface of an “Update Your Profile Settings” screen 194 is provided. The “Update Your Profile Settings” Screen 194 may be accessed via the “Settings” tab 196 of the dashboard 130. Through this screen 194, the student's. login Email ID and password may be changed.

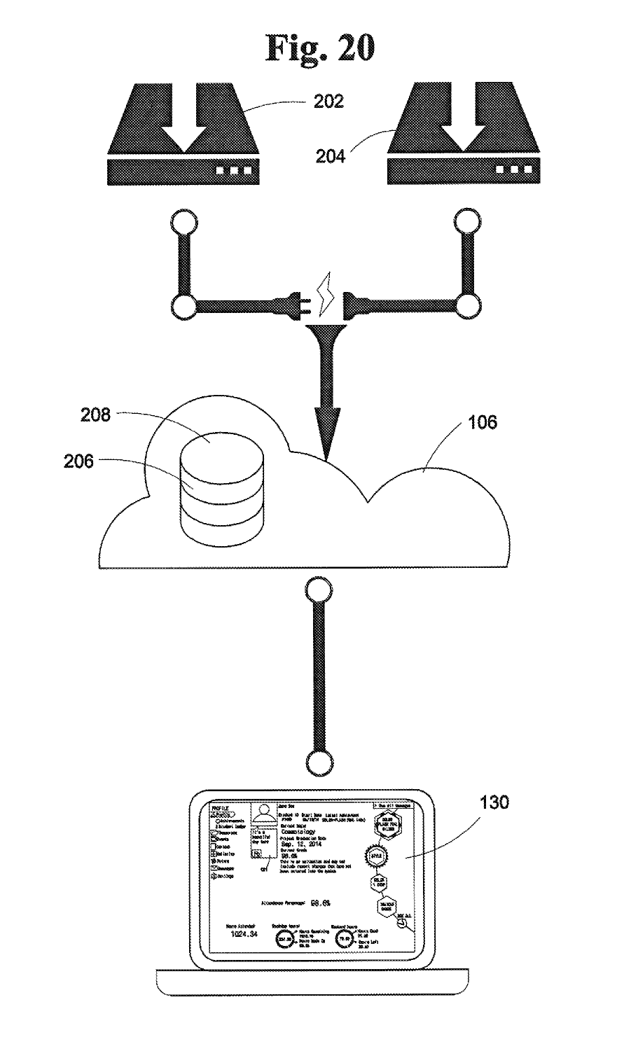

FIG. 20 provides an alternative embodiment of the system 100 wherein information is extracted from one or more data sources 202 and 204, including the client organization data source(s) and/or remote data sources, are integrated into an internal database 206 that is housed within the remote/cloud server 106. This allows the system 100 to operate as a Software-as-a-Service (“SaaS”) to an organization and its students/users. Authorized administrators may still access the cloud server 106 to maintain their particular organization's sub-database and rules 208, but do not need to undertake the expense of maintaining a separate server and client installation process to utilize the system 100. The SaaS implementation allows the system 100 to operate with any internet connected client device 107. However, it should be appreciated by one skilled in the art that the system 100 may be implemented utilizing alternative delivery methods without departing from the scope of the present invention.

In addition to current students, it is anticipated that a system 100 of the present invention will also have functionality for alumni. Alumni may use the system 100 to view job postings, communicate with the school, organize/view continuing education classes, and more. Alumni profile information may include current job placement. Moreover, the system 100 may provide a gateway for networking between alumni and students, which will also help to motive students. It is anticipated that the system 100 will provide discussion forums for this purpose, and to provide a means for communication between alumni.

In addition to faculty, administrators, students, and alumni, it is anticipated that a system 100 of the present invention will also have functionality for front-end, school owners and on-site training locations, such as salons, that employ students or participate in work-study programs. Business owners may use the system 100 to find potential employees, track student performance for those students that choose to share such information or for students assigned to their location, post job openings, track sales, and/or project cash flows. School owners can track their cash flows and project estimated cash flows for future periods in the system 100 by importing accounting data into the system 100. Furthermore, salon owners, may track student employee performance and revenues as well as utilize the system 100 to post job openings and search for potential, qualified candidates. Salon owners may also track accounting and cash-flow performance of the salon as well as project estimated future cash-flows through the system 100.

It is clear from the foregoing description that a number of parties benefit from the system 100. School officials benefit by having an efficient means of communication with student and the ability to quickly view all student information. Moreover, by viewing student information, educators may individualize instruction and motivate specific students as needed. This instruction, as well as the motivation created by earning achievements and viewing current progress information, will help students remain goal-oriented and focused, which will lead to higher graduation rates and career placement. Moreover, potential employers benefit from having ready access to national, regional, school, and student information. Salon owners benefit from having ready access to financial information, easily accessible job postings, and student information for potential hires that agree to submit such information. School administrators, staff, and ownership are able to easily view information necessary to improve the school and enhance education. In addition, a brand with which the school is affiliated can view national, regional, school, and student information as necessary for its purposes.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between a network connection of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A system comprising a first computer having:
a first processor;
a first machine-readable medium storing a set of instructions that, when executed by said first processor, cause said first processor to execute operations comprising:
gathering data from at least one external program;
allowing access to said data based on pre-defined account types;
providing a user interface for registration of at least one account;
providing student data in said system from said data from said at least one external program;
providing administrative, financial, and business data in said system from said data from said at least one external program; and
providing analysis based on user requests using said data from said at least one external program.

2. The system of claim 1 wherein said gathered data is selected from the group consisting of: administrative data, financial data, business data, student data, school administration data, and combinations thereof.

3. The system of claim 1 further comprising a second computer having a second processor and a second machine readable medium storing said at least one external program from which said first computer gathers said data.

4. The system of claim 2 wherein said operations further comprise awarding at least one achievement based on said student data.

5. The system of claim 4 wherein said operations further comprise providing a social media platform.

6. The system of claim 5 wherein a student can share said at least one achievement via said social media platform.

7. The system of claim 1 wherein at least one of said operations is carried out via an application programming interface.

8. The system of claim 1 wherein said operations further comprise gathering and displaying employment data.

9. The system of claim 2 wherein said operations further comprise building a resume based on said student data.

10. The system of claim 1 wherein said operations further comprise providing a payment gateway.

11. The system of claim 10 wherein said payment gateway allows a student to make a payment to a school.

12. The system of claim 10 wherein said payment gateway allows a school to make a payment to a vendor.

13. The system of claim 1 wherein said operations further comprise providing a communication platform.

14. The system of claim 13 wherein said communication platform allows a school to communicate with at least one student via push technology.

15. The system of claim 13 wherein said communication platform allows a student to communicate with a school via a pre-populated form.

16. The system of claim 2 wherein said operations further comprise creating a warning when said student data reaches a preset value.

17. The system of claim 4 wherein said at least one achievement is customizable.

18. The system of claim 2 wherein said student data is selected from the group consisting of: name, demographic information achievements, benchmarks, financial information, curriculum, events, examples of student work, employment information, contacts, messages, social media, services performed, retail sales, grade information, client information, resume, continuing education information, attendance information, class rank, and combinations thereof.

19. The system of claim 1 wherein said student profile is accessible via at least one of a desktop computer, tablet computer, and mobile device.

20. The system of claim 2 wherein said business and financial data is imported from said at least one external program and analyzed for projecting future cash flows.

21. The system of claim 2 wherein said business and financial data is imported from said at least one external program and analyzed for performance tracking and accounting purposes.

22. A computer-implemented method comprising:
gathering data from at least one external program;
providing business and financial analysis of said data;
creating a user interface to access said data;
creating a student profile displaying a particular student's data;
providing said student with access to said student profile; and
providing access to said data and analysis through said user interface.

23. The computer-implemented method of claim 22 wherein said gathered data is selected from the group consisting of: administrative data, financial data, business data, student data, school administration data, and combinations thereof.

24. A system comprising a first computer having:
A first processor;
a first machine-readable medium storing a set of instructions that, when executed by said first processor, cause said first processor to execute operations comprising:
gathering student, financial, business, and school administration data from at least one external program;
creating a student profile from said student data;
awarding at least one achievement based on said student data;
providing a social media platform;
gathering and displaying employment data;
providing a communication platform;
providing a payment gateway;
building a student resume; and
creating a warning when said student data reaches a preset value.

25. The system of claim 24 wherein said student data is selected from the group consisting of: name, demographic information, achievements, benchmarks, financial information, curriculum, events, examples of student work, employment information, contacts, messages, social media, services performed, retail sales, grade information, client information, resume, continuing education information, attendance information, class rank, and combinations thereof.

26. The system of claim 24 wherein at least one of said operations is carried out via an application programming interface.

27. The system of claim 24 wherein said business and financial data is imported from said at least one external program and analyzed for projecting future cash flows and analyzed for performance tracking and accounting purposes.

28. A system comprising a first computer having:
A first processor;
a first machine-readable medium storing a set of instructions that, when executed by said first processor, cause said first processor to execute operations comprising:
gathering student, financial, business, and school administration data from at least one external program;
creating a student profile from said student data;
awarding at least one achievement based on said student data;
providing a social media platform;
gathering and displaying employment data;
providing a communication platform;
providing a payment gateway;
building a student resume; and
creating a warning when said student data reaches a preset value.
wherein said student data is selected from the group consisting of: name, demographic information, achievements, benchmarks, financial information, curriculum, events, examples of student work, employment information, contacts, messages, social media, services performed, retail sales, grade information, client information, resume, continuing education information, attendance information, class rank, and combinations thereof;
wherein at least one of said operations is carried out via an application programming interface; and
wherein said business and financial data is imported from said at least one external program and analyzed for projecting future cash flows and analyzed for performance tracking and accounting purposes.
